(19) United States
(12) Patent Application Publication
(10) Pub. No.: US 2012/0197722 A1
(43) Pub. Date: Aug. 2, 2012

(54) GROUP BUYING SEARCH

(75) Inventor: Gregory J. Mesaros, Westlake, OH (US)

(73) Assignee: EWINWIN, INC., Westlake, OH (US)

(21) Appl. No.: 11/680,431

(22) Filed: Feb. 28, 2007

Related U.S. Application Data
(63) Continuation-in-part of application No. 11/464,376, filed on Aug. 14, 2006, now Pat. No. 7,689,469.

(51) Int. Cl. G06Q 30/02

(52) U.S. Cl. 705/14.58

(57) ABSTRACT

A group buying system includes a search engine operable to present group purchasing events to consumers. Consumers utilizing the search engine supply criteria relating to product descriptions, purchasing terms, offer features or the like. The search engine retrieves group purchasing events from one or more sellers in accordance with the supplied criteria. Furthermore, mechanisms are provided to enable the search engine to discover new offers posted by sellers on other systems.

### CROSS-REFERENCE TO RELATED APPLICATIONS

This application is a continuation-in-part of co-pending U.S. application Ser. No. 11/464,376, filed Aug. 14, 2006 and entitled E-COMMERCE VOLUME PRICING, the entirety of which is incorporated herein by reference.

### BACKGROUND

The buying and selling of goods and services (collectively referred to as “products”) has resulted in a vast array of costing schemes, which are used to select the price at which such products are sold. One of the most common costing schemes which consumers encounter everyday is known as fixed pricing. According to this costing scheme, sellers set a fixed price for their products based on a past demand for the product and/or anticipated future demand. Buyers desiring to purchase products from the seller are each required to pay the same fixed price regardless of the number of products purchased. If a seller finds that the demand for a given product is greater or less than expected, the seller may later adjust the fixed price of the product to account for such findings. Although the fixed pricing provides a simple way for a seller to conduct business with multiple buyers, one drawback of this costing scheme is that it fails to reward buyers willing to purchase greater quantities of products. Accordingly, the discount quantity pricing scheme evolved.

The discount quantity pricing approach to costing involves pricing a product at different levels depending on the quantity of products a customer is willing to purchase. The more products a customer is willing to purchase, the lower the price. Sellers have incentive to lower price for large quantity buyers since the fixed costs associated with producing the product is spread over more items. Thus, sellers are able to make equal or greater profits despite the lowered price of the product. While volume pricing offers a benefit to larger buyers who are able to purchase large quantities of goods at one time, smaller buyers are often unable to obtain the lowered prices and therefore are more likely to “shop around” for the best available deal. This, in turn, hurts both the buyer and seller. For instance, the smaller buyer is burdened with needing to search for alternative deals and still often ends up paying a higher price than larger buyers. The sellers, on the other hand, are faced with lost business since they are unable to reduce their price for the smaller buyers and still make sufficient profit.

Another common costing scheme for pricing a product is an auction. In an auction, a seller sets an initial price for an item and then multiple buyers are given an opportunity to bid against each other for the product. The buyer having placed the highest bid for the product at the end of the auction purchases the product at the final price bid. In order to provide a larger forum for buyers and sellers, a recent trend has been to auction goods electronically over the Internet. For example, one company known to operate an auction site over the Internet is eBay, Inc. Although auctions provide advantages when selling unique products for which customers are willing to competitively bid, the auction forum is not well suited for sellers desiring to sell large quantities of goods to multiple buyers given the inherent inefficiencies involved with selling one product at a time in a bidding environment.

Yet another costing scheme, which has been advanced in recent years, is buyer-driven bidding. According to this costing scheme, a single buyer desiring to obtain a product communicates a price at which the buyer is willing to purchase the product to multiple sellers. Each of the sellers is provided an opportunity to review the buyer's price. A sale is complete when one of the sellers agrees to sell the product to the buyer at the price suggested by the buyer. A buyer-driven bidding scheme is described in U.S. Pat. No. 5,794,207 assigned to Walker Asset Management Limited Partnership of Stamford, Conn. While the buyer-driven bidding scheme provides advantages for certain types of transactions when, for example, sellers may be willing to sell products at lower than normal prices, the uncertainties involved with whether a buyer's offer will be accepted is often problematic for high volume commercial transactions in which the reliability that a transaction will be complete is of paramount importance.

While the costing schemes described above have various advantages and disadvantages in different situations, a commonality among all of the costing schemes is that each buyer operates independently with one or more sellers to set a purchase price of a product. For example, in the fixed pricing scheme and discount quantity purchasing scheme, buyers individually determine whether the sellers preset price schedule is acceptable regardless of whether other buyers have decided to purchase the product or not. In an auction, not only do buyers operate independent of other buyers but, in fact, each buyer's decision to place a bid has a negative effect on all other buyers desiring to purchase the same good since the price of the good increases. Similarly, in a buyer-driven bidding scheme, each buyer is completely unaware of the amount other buyers are bidding for a given product.

The independent operations of the buyers stems from a combination of the fact that: 1) the costing schemes discussed above provide little incentive for buyers to work together and 2) there are large inconveniences for buyers to facilitate communication about their buying activities to other buyers. Unfortunately, such independent operation by buyers can result in missed opportunities for both the buyer and seller. For example, in instances where two independent buyers are unable to afford a product, neither buyer informs the seller of their respective desire to purchase the product. Accordingly, sales of the product to these buyers do not take place. Due to the independent operations by each of the buyers, such information is never communicated thereby resulting in missed opportunities for both the buyers and seller alike.

### SUMMARY

The following presents a simplified summary in order to provide a basic understanding of some aspects of the claimed subject matter. This summary is not an extensive overview. It is not intended to identify key/critical elements or to delineate the scope of the subject invention. Its sole purpose is to present some concepts in a simplified form as a prelude to the more detailed description that is presented later.

Briefly described, the subject disclosure pertains to systems and methods directed toward e-commerce transactions and demand aggregation. More particularly, mechanisms are provided to assist consumers in discovering desired goods and/or services included in group purchasing events by a plurality of sellers whereby the price paid by consumers is a function of the total purchases under the event. For some sellers, it is difficult to inform consumers of a particular sale or event. For example, advertising in periodicals or on television and/or radio are broad, undirected means of advertising. By providing directed events to already interested consumers, sellers are motivated to participate in group pricing and demand aggregation in order to achieve effective advertising. Further, both consumers and sellers can benefit from such group pricing and demand aggregation. For example, sellers can utilize group purchasing deal rooms for optimal production scheduling and/or inventory reduction, while consumers can be joined to benefit from bulk discounts that may be otherwise unavailable to individuals or small entities.

According to aspect of this disclosure, a group purchasing event discovery system is provided that includes a search component. The search component includes a query component that accepts a search query from a consumer. The search query is employed to retrieve group purchasing events from one or more sellers. A consumer may review the retrieved events and select one to begin transacting with the seller.

In accordance with another aspect of the claimed subject matter, a mechanism is provided to locate, retrieve and index group purchasing events. Sellers can post metatags describing group purchasing events to a website or other location on the Internet. These offers are discovered and indexed in a database for future retrieval.

According to yet another aspect of the disclosure, mechanisms are provided to record and data mine consumer search history data. Consumer search habits can be analyzed to determine patterns useful in providing more relevant group purchasing events. Additionally, mechanisms are provided to track group purchasing events. Events can be monitored by consumers in order to discover the best deal.

To the accomplishment of the foregoing and related ends, the invention then, comprises the features hereinafter fully described and particularly pointed out in the claims. The following description and the annexed drawings set forth in detail certain illustrative aspects of the invention. These aspects are indicative, however, of but a few of the various ways in which the principles of the invention may be employed and the subject invention is intended to include all such aspects and their equivalents. Other objects, advantages and novel features of the invention will become apparent from the following detailed description of the invention when considered in conjunction with the drawings.

### BRIEF DESCRIPTION OF THE DRAWINGS

FIG. 1 illustrates a diagrammatic view of a system for electronically conducting business.

FIG. 2 is a block diagram of a representative central server in accordance with an aspect of the innovation.

FIG. 3 illustrates an exemplary web page providing options to buyers and sellers desiring to conduct business electronically.

FIG. 4 illustrates a deal room in which buyers may place electronic orders for products posted by sellers.

FIG. 5 is a flow chart diagram for a buyer desiring to conduct business electronically.

FIG. 6 illustrates an on-line registration form for a buyer.

FIG. 7 illustrates a representative buyer database.

FIG. 8 is a web page for a buyer to search for a desired deal room.

FIG. 9 is a flow chart diagram for a seller desiring to conduct business electronically.

FIG. 10 illustrates an on-line registration form for a seller.

FIG. 11 illustrates a representative seller database.

FIG. 12 illustrates a representative web page for a seller to open or visit a deal room.

FIG. 13 illustrates a product information sheet completed by a seller opening a deal room.

FIG. 14 is a block diagram of a group purchasing event search system.

FIG. 15 is a block diagram of a representative search component.

FIG. 16 is a block diagram of a group purchasing event discovery system.

FIG. 17 is a block diagram of a group purchasing search system including a search history component.

FIG. 18 is a block diagram of a group purchasing event tracking system.

FIG. 19 is a flow chart diagram of a method of group purchase event searching.

FIG. 20 is a flow chart diagram of a method of discovering group purchasing events.

FIG. 21 is a flow chart diagram of a method of group purchase event tracking.

FIG. 22 is a flow chart diagram of a method of data mining buyer search history data.

FIG. 23 is a schematic block diagram illustrating a suitable operating environment for aspects of the subject innovation.

FIG. 24 is a schematic block diagram of a sample-computing environment.

### DETAILED DESCRIPTION

The subject disclosure pertains to searching for group purchasing events. More specifically, the disclosure is related to mechanisms that facilitate discovery, gathering and indexing of group purchasing events to be retrieved later by interested consumers. In accordance with one embodiment, a search engine is provided. The search engine includes mechanisms to scour the Internet or local networks for group purchasing events posted by sellers. The group purchasing events include price curves that that vary as a function of an amount of product ordered/purchased. A buyer, desiring to aggregate purchases with other buyers, utilizes the search engine to find group purchasing events and to participate in electronic deal rooms attached to the events. Various systems and methods are described hereinafter with respect to group purchase event searching as well as relevant tools to aid such functionality.

Various aspects of the subject disclosure are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents and alternatives falling within the spirit and scope of the claimed subject matter.

Initially, what follows is an exemplary implementation of a demand aggregation system as well as system setup and interaction therewith. It is to be appreciated that this is but one manner in which aspects of the disclosure can be employed. Others are possible and are to be deemed within the scope of the claimed subject matter. Further yet additional details regarding the below described mechanisms and interactions can be found in the aforementioned patent application entitled E-COMMERCE VOLUME PRICING, incorporated herein by reference.

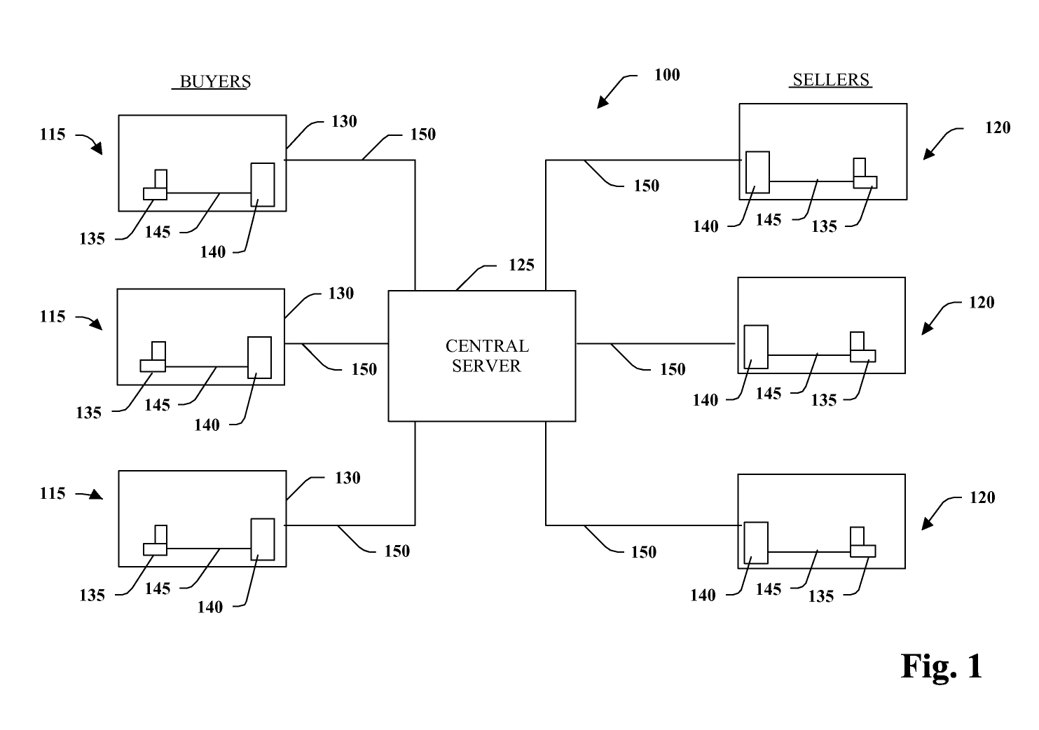

Referring to FIG. 1, a system 100 is shown in which multiple buyers 115 and sellers 120 are electronically linked via a central server 125. As discussed in more detail below, the central server 125 is configured to provide the buyers 115 and sellers 120 with a convenient forum in which to buy and sell goods in accordance with a volume pricing methodology described herein. The forum may, for example, be a pre-established Internet web page where sellers 120 are able to post product information and the buyers 115 are able to order the products. The volume pricing scheme preferably calls for a seller 120 to post a pricing structure for a product which provides discounted pricing as more products are purchased during a preset “open session” period. Each buyer 115 is able to place an order for the product during the open session at the then current price. At the end of the open session, the total quantity of products ordered by all buyers 115 is calculated, and the product is sold to all buyers 115 at the same lowest price based on the preset price for that quantity amount. In this manner, each of the buyers 115 work together to increase the total quantity of products purchased so that all of the buyers 115 realize discounted pricing due to the cumulative order.

Each of the buyers 115 and sellers 120 may access the central server 125 in any of a variety of ways. For example, in the subject embodiment, each buyer 115 and seller 120 is shown to be part of separate establishments 130 which include one or more respective computer systems 135 and local servers 140. The computer systems 135 may, for example, be a desktop or laptop computer with a local area network (LAN) interface for communicating over a network backbone 145 to the local server 140. The local servers 140, in turn, interface with the central server 125 via a network cable 150 or the like. It will be appreciated that while the subject embodiment depicts the computer system 135 communicating with the central server 125 via hardwired network connections, in an alternative embodiment the computer system 135 may interface with the central server 125 using a modem, wireless local area and/or wide area networks, etc. Further, it will be appreciated, that while the buyers 115 and sellers 120 are shown to communicate with the central server 125 via different computer systems 135, it will be appreciated that the buyers 115 and/or sellers 120 may access the central server 125 from the same computer system 135.

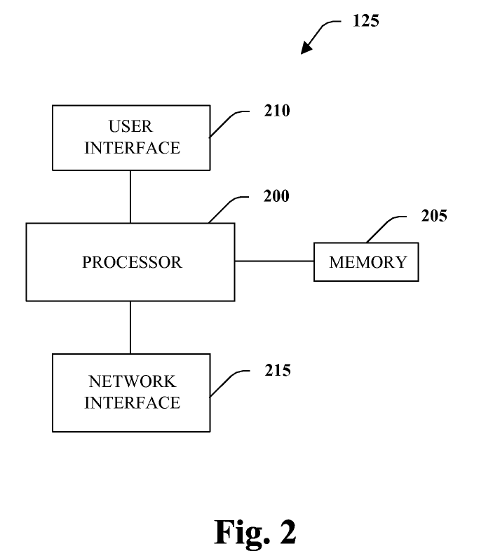

Turning now to FIG. 2, a block diagram of the hardware components of the central server 125 is shown. In particular, the central server 125 includes a central processor 200 for performing the various functions described herein. A memory 205 is coupled to the processor 200 and stores operating code and other data associated with the operations of the central server 125. A user interface 210 is also coupled to the processor 200 and provides an interface through which the central server 125 may be directly programmed or accessed. The user interface 210 may, for example, be an alphanumeric keyboard and mouse. A network interface 215 coupled to the processor 200 provides multiple connections for transceiving information with buyers 115 and sellers 120 over the network cables 150.

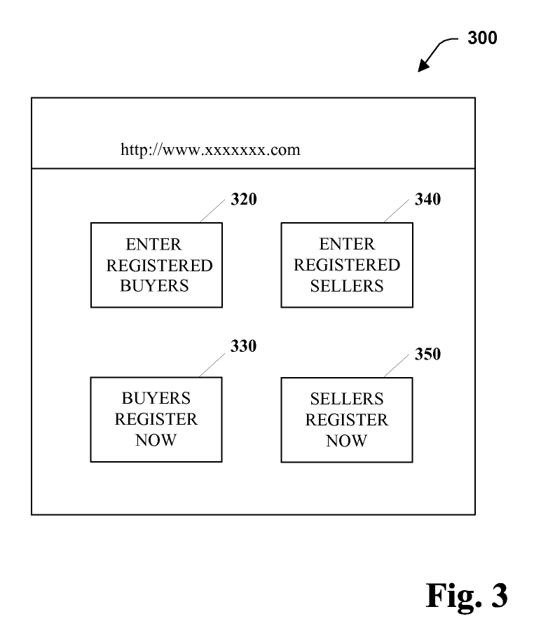

Turning now to FIG. 3, an exemplary Internet web page 300 which provides buyers 115 and sellers 120 with access to a forum for conducting business using the volume pricing methodology described in detail below is shown. The web page 300 is shown in to include hyperlinks for handling both registered and un-registered buyers and sellers of products. For example, as shown in FIG. 3, registered buyers may select a hyperlink to a registered buyer login screen via hyperlink 320 while non-registered buyers may select a hyperlink to a non-registered buyer registration screen via hyperlink 330. Similarly, registered sellers may select a hyperlink to a registered seller login screen via hyperlink 340, while non-registered sellers may select a hyperlink to a non-registered seller registration screen via hyperlink 350. While the present embodiment shows separate hyperlinks for buyers and sellers, it will be appreciated that such hyperlinks could alternatively be combined and the status of buyer or seller could be determined during a later stage in the login procedure.

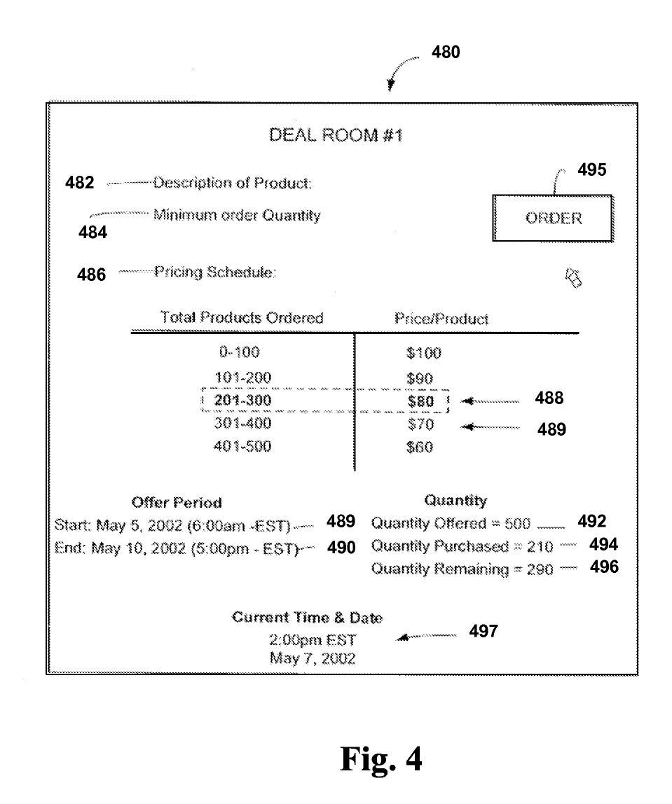

Turning now to FIG. 4, in accordance with one embodiment of the subject claimed innovation, registered sellers 120 set up deal rooms 480 in which registered buyers 115 are able to order products. The deal rooms 480 provide a convenient forum for sellers to receive orders from multiple buyers during an “open session” period. Based on the cumulative orders received at the end of the open session period, a seller provides all buyers with the same quantity discount for the product regardless of what the price of the product was at the time each buyer placed the order. Thus, in accordance with the subject embodiment, each buyer is able to benefit from other buyers ordering the same product since the cumulative orders received at the end of the open session determines the price for all buyers 115 placing orders during the open session.

As will be discussed in more detail below, the deal rooms 480 of the subject embodiment are set up to display the following information which is input from the seller 120 and/or calculated by the processor 200 of the central processor 125 during an open session: product name/description 482; minimum order quantity 484; price schedule 486 with current price level highlighted 488; offer start time 489; offer end time 490; total quantity of products made available 492; total quantity purchased to date 494; total quantity available 496; current time and date 497. The time between the offer start time and the offer end time is referred to as the “open session” period. Based on such information, buyers 115 visiting the deal room 480 can make an informed decision as to whether they desire to place an order for the product. If a buyer 115 desires to place an order, the buyer 115 selects an order icon 495 displayed within the deal room 480 to continue the purchasing actions.

For example, in the deal room 480 shown in FIG. 4, a buyer (Buyer A) visiting the deal room 480 at time t1 may initially review the current price of a product as highlighted at 488 and review the end time 490 for the product offering. At time t1, the price for the product as highlighted at 488 indicates that the price/product is $80. Further, the total products ordered to date is shown to be a quantity of 220. Buyer A next determines whether they are interested in purchasing the product keeping in mind the minimum order quantity set by the seller 120 which in this case is 10 units. If Buyer A decides to order the product, Buyer A selects the order icon 495 and places an order for a desired quantity. In the present example, Buyer A places an order for 70 products. After the order is placed, the total products ordered to data is 290 (220-t 70) and the price/product remains at $80 as determined from the pricing schedule 486. Next, at time t2, another buyer (Buyer B) enters the deal room and decides to place an order for 30 more products. After Buyer B places the order, the total products ordered to date is 320 (290+30) and the price/product is lowered to $70 as determined from the pricing schedule. The placing of orders by additional buyers continues until the open session period is over. At the end of the open session period, the price of the product to all of the buyers is the price at the time the open session period ended. For example, in the present instance, if the open session period ended after Buyer B placed their order, the price of the product for Buyer A, Buyer B and all other buyers ordering products during the open session period is $70 even though orders by one or more buyers may have been placed at a higher price level. In this manner, the buyers are able to work together to lower the cost of a product for all 20 buyers. Further, even small buyers who would otherwise not be able to obtain volume discount pricing are able to share in the lowered cost and provide a benefit to the larger buyers.

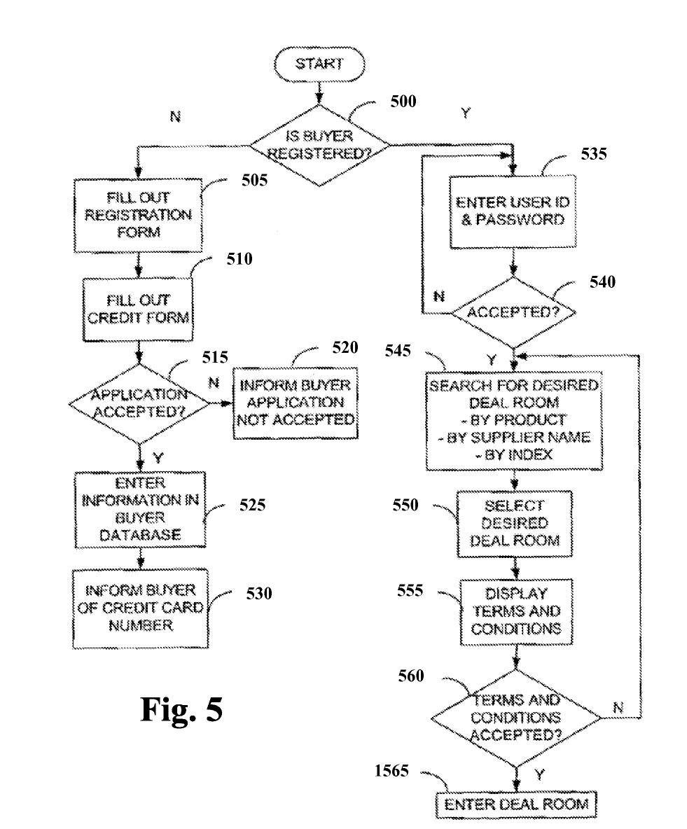

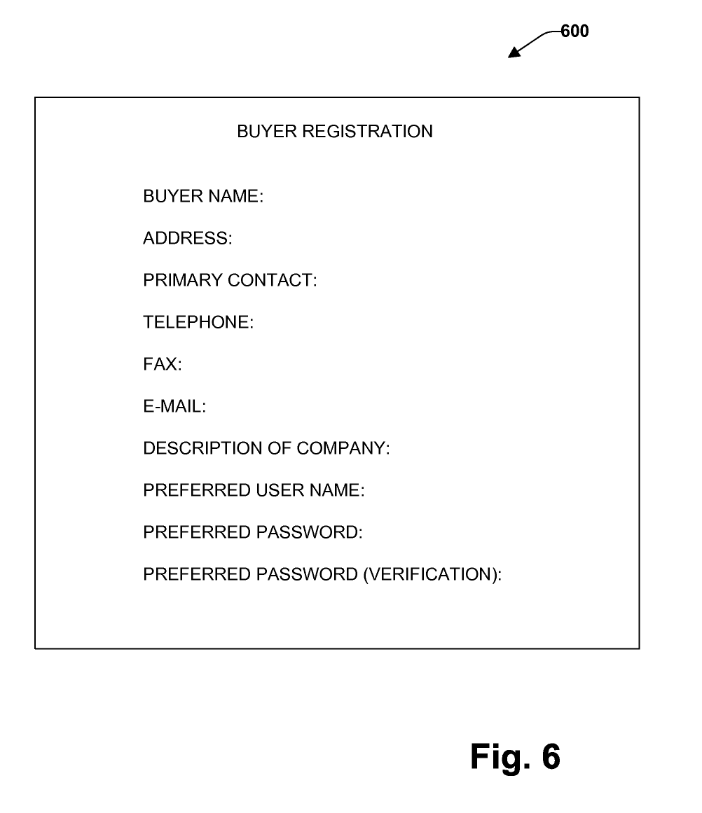

Turning now to FIG. 5, the general actions taken by a buyer 115 entering the web page 300 is shown. More particularly, in act 500 it is initially determined whether a buyer 115 is registered or not. If the buyer 115 is not registered, the buyer 115 selects hyperlink 330 (FIG. 3) and proceeds to 505. At 505 the processor 200 of the central server 125 request that the buyer 115 fill out a registration form. For example, the buyer 115 is requested to fill out a registration form 600 such as that shown in FIG. 6. In the present example, the registration form 600 requests that the buyer 115 enter the following information: buyer name; address; primary contact person; phone; fax; e-mail; short description of company; preferred login user name; and preferred password. With respect to the user name and password, the processor 200 is configured to determine whether the selected user name and password combination are available and, if not, to prompt the buyer 115 to enter a new user name and password until an available combination is selected.

Continuing to refer to FIG. 5, in step 510, the buyer is requested to fill out a credit card application so that purchases made on the web site may be immediately approved. The credit card registration and approval process may be accomplished via a hyperlink to one of various electronic credit card approval agencies which check the buyer's credit rating and set up a merchant account with a line of credit. For example, an electronic credit card approval agency may be used in conjunction with the subject invention. Next, at 515, the processor 200 determines if the credit card application has been approved by the electronic credit card approval agency. If the credit card application has not been approved, the processor 200 proceeds to act 520 where a message is sent back to the buyer 115 indicating regret that they have not been approved for a line of credit and therefore have not successfully completed the registration process. At numeral 520, a customer service telephone number also is provided to the buyer 115 in case the buyer has questions and/or desires to pursue registration further.

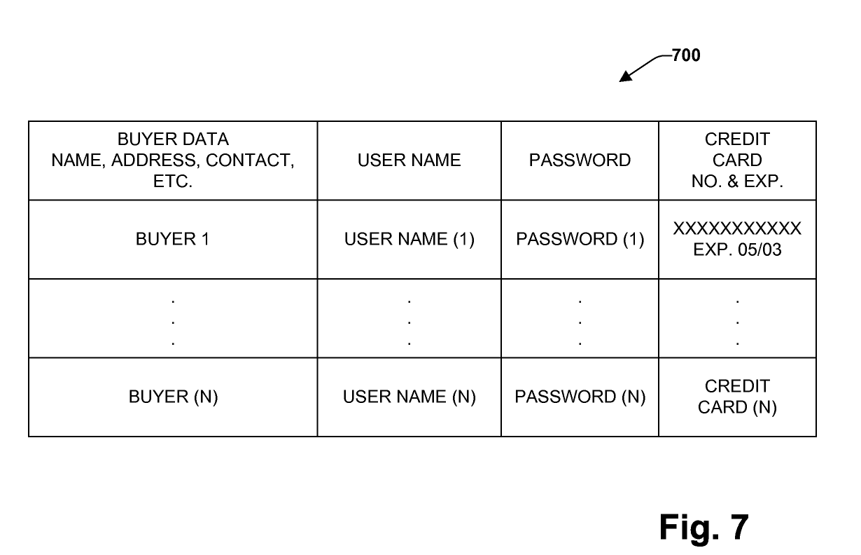

If in act 515, the processor 200 is informed that the buyer 115 has been provided a line of credit and a credit card number has been issued, the processor 1200 proceeds to 525. At 525, the buyer information from the registration form 600 and the newly issued credit card number are stored in a buyer database 700 (FIG. 7) in the memory 205 of the processor 125 (FIG. 2), for example. Next, at 530, the processor 200 is configured to provide the buyer 115 with the newly issued credit card number so that the buyer 115 is able to purchase products. Further, the processor 200 is configured to provide a report to a system administrator who then mails a confirmation copy of the buyer's information stored in the buyer's database to the buyer 115. This completes the buyer's registration process.

Continuing to refer to FIG. 5, if at 500, a buyer has already registered, the buyer 115 may login as a registered user by selecting the registered user hyperlink 320 (FIG. 3). Once selected, the processor 200, at 540 prompts the buyer 115 to enter their user ID and password/pass code. Upon entry of such information, the processor 200 at 540 verifies the user ID and password with those stored in the buyer database. If the user ID and password entered by the buyer 115 does not match any entry in the buyer database, the processor 200 at 540 returns to numeral 535 for re-entry of such information. If, however, at 540, a valid user ID and password are entered, the processor 200 proceeds reference numeral 545.

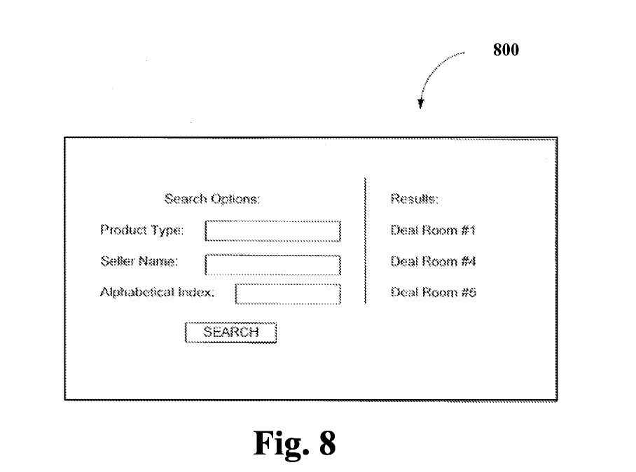

At 545, the processor 200 provides the buyer 115 with a search screen where the buyer 115 is able to select various deal rooms 480 they wish to enter. As discussed above, the deal rooms 480 provide the buyer 115 with information regarding the sale of a particular product such as, for example, the price structure set up by the seller for the product, the quantity of products sold to date, the time remaining to purchase a product, etc. In order to allow a buyer to quickly find deal rooms 480 of interest, the 125 processor 200 at 545 provides the buyer 115 with a search screen 800 so that active deal rooms 480 of interest may be found. As shown in FIG. 8, in the subject embodiment, the buyer 115 is provided with the ability to search based on a variety of different search criteria including “product type”, “seller name”, and “alphabetical index”. Of course, various other manners for allowing a buyer 115 to select or find a deal room could alternatively be used.

Once a search is completed, the buyer 115 in step 550 is able to select a desired deal room 480 from the results obtained. For example, the buyer 115 may click on the name of a desired deal room (FIG. 8) using a mouse associated with the computer system 135. If the buyer 115 is unsatisfied with the search results or simply desires to re-perform the search, the buyer 115 at any time is able to return back to a previous screen selecting the “back” function available using an Internet browser such as, for example, Microsoft Internet Explorer, Netscape, etc. Additionally, a hyperlink to various screens, such as the search screen, preferably is provided on each web page.

Upon selecting a deal room 480, the processor 200 at 555 displays a page of standard terms and conditions which the buyer 115 needs agree to prior to entering the deal room. The terms and conditions relate to the terms governing the sale of the product according to which both the buyer and seller are willing to conduct business. If the terms and conditions are not accepted, the processor 200 returns the buyer 115 to numeral 545 so that another deal room 480 may be selected and/or another search may be performed. If, however, at 560 the terms and conditions are accepted, the processor 200 proceeds to allow the buyer 115 to enter the selected deal room 480 at 565.

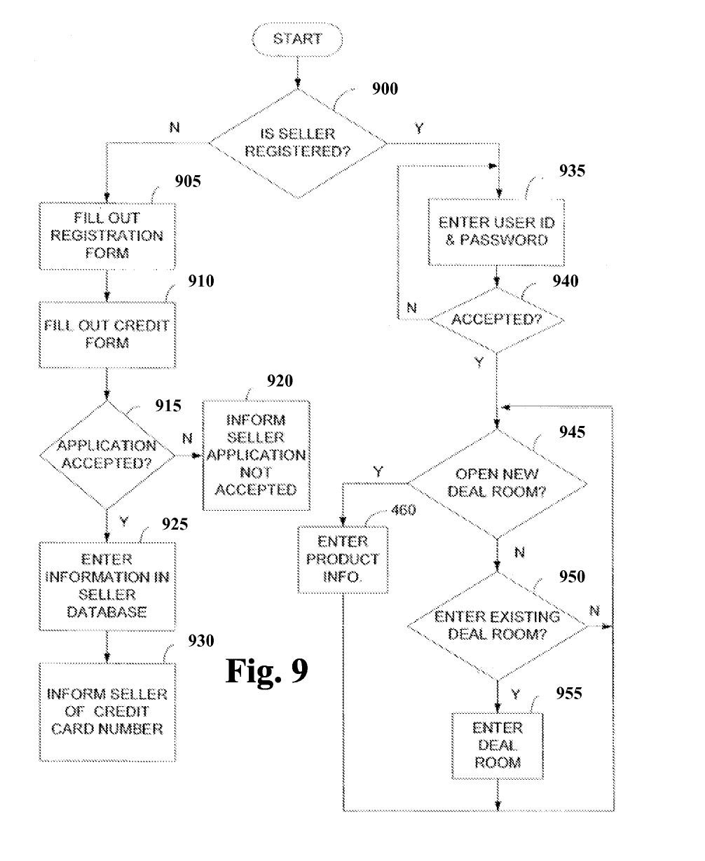

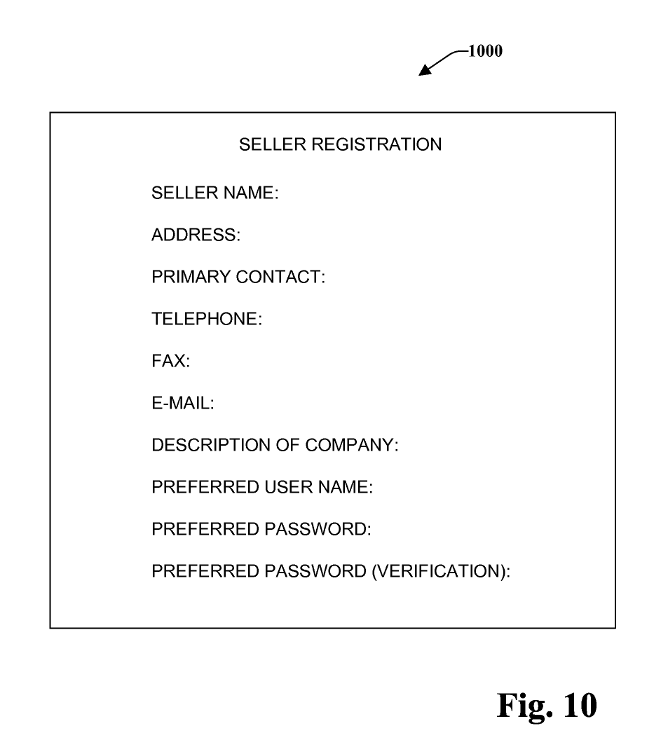

Proceeding now to FIG. 9, the operations of the processor 200 of the central server 125 in handling sellers 120 is depicted. In particular, the processor 200 at numeral 900 initially determines whether a seller 120 is registered or not based on which hyperlink 340, 350 (FIG. 3) the seller 320 selects. If the seller 120 selects hyperlink 350 indicating the seller is not registered, the processor 200 proceeds to numeral 905. At 905, the processor 200 provides the seller 120 with a seller's registration form 1000 (FIG. 10) to fill out. The registration form 1000 is similar to the registration form 600 for the buyer 115 and allows the seller 120 to select a preferred user ID and password. Once completed, the processor 200 proceeds to step 910 where the seller 120 is requested to submit a credit card application so that all costs and fees associated with conducting business using deal rooms may be directly billed to the seller's credit card. As discussed above, the credit card approval process may occur by a third party vendor accessible via a hyperlink.

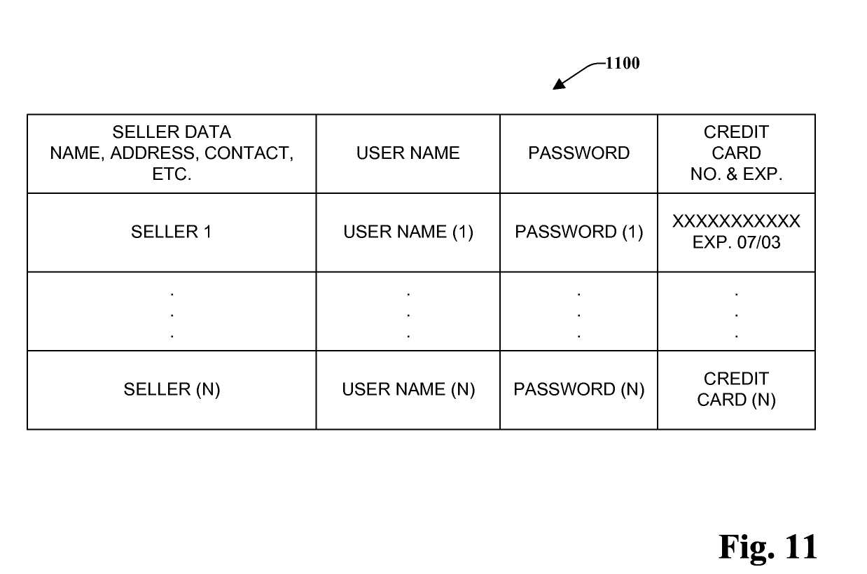

Once the credit card application is submitted by the seller 120, the processor 200 proceeds to act 915 where the processor 200 determines if the credit card application has been approved. If the credit card application has not been approved, the processor 200 proceeds to numeral 920 where the seller 120 is informed that their credit card application has not been approved and the seller 120 is provided with a customer service telephone number so that the seller 120 may optionally set up the account in a different fashion. If, however, at numeral 915 the credit card application is accepted, the processor 200 proceeds to act 925 where the seller information is stored in a seller database 1100 (FIG. 11). Finally, at numeral 930, the processor 200 is configured to provide the seller 120 with the newly issued credit card number so that the seller 120 is able to open deal rooms. Further, the processor 200 is configured to provide a report to a system administrator who then mails a confirmation copy of the seller's information stored in the seller's database to the seller 120. This completes the seller's registration process.

Continuing to refer to FIG. 9, if at 900 a seller has already registered, the seller 120 may login as a registered user by selecting the registered user hyperlink 340 (FIG. 3). Once selected, the processor 200, at 935 prompts the seller 120 to enter their user ID and password. Upon input of the user ID and password, the processor 200 proceeds to act 940 where the processor 200 verifies a valid user ID and password have been entered by comparison with the information stored in the seller database 1100 (FIG. 11). If the user ID and password entered by the seller 120 does not match any entry in the seller database 1100, the processor 200 at 940 returns to 935 for re-entry of such information. If, however, at 940, a valid user ID and password are entered, the processor 200 proceeds to numeral 945.

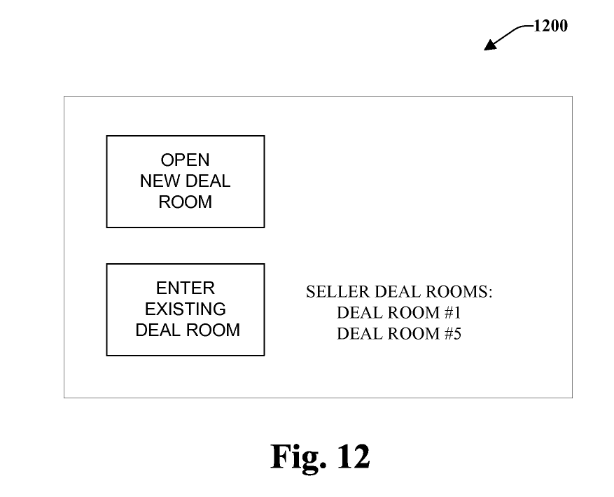

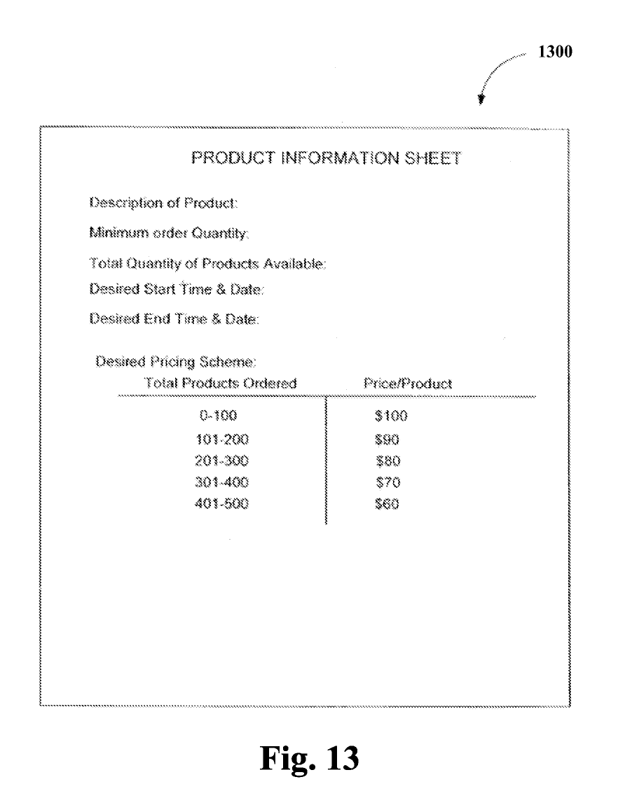

Upon successful entry of a user ID and password, the seller 120 is provided with a seller option screen 1200 as shown in FIG. 12. For example, the seller 120 may decide to open a new deal room 480 where a product may be placed for sale or the seller 120 may decide to view a current deal room 480 to determine the status of a given transaction. Accordingly, if at 945, the processor 200 determines that the seller 120 desires to open a new deal room, the processor 200 proceeds to act 960. At 960, the processor 200 requests that the seller 120 enter the product information for the deal room they desire to open into a product information screen 1300. For example, in the subject embodiment the information requested is shown in FIG. 13 to include: product name and short description; minimum order quantity accepted; total quantity of products available; start time for offer; end time for offer; and a product pricing schedule. As discussed above, the processor 200 utilizes the information input from the seller 120 to display deal rooms 480 for viewing by registered buyers 115.

Continuing to refer to FIG. 9, if at 945, the seller 120 has not selected to open a deal room, the processor 200 determines at 950 whether the seller 120 has decided to enter an existing deal room 480. In the subject embodiment of the invention, the seller 120 is limited to entering those deal rooms which they have opened. Accordingly, if the processor 200 determines that the seller does desire to enter a deal room 480, the processor 200 provides the seller 120 with a list of deal rooms 480 which the seller has opened. Upon selection of one of the deal rooms 480, the processor 200 proceeds to numeral 955 where the deal room 480 is displayed to the seller 120. If a deal room 480 is not entered in 950, or following acts 955 and 960, the processor 200 returns to numeral 945.

What follows now are systems and methods for group purchasing event searching. Mechanisms are described wherein consumers employ a search engine to retrieve group purchasing events. Consumers may select a group purchasing event and purchase goods and/or services, for example, in the aforementioned manner.

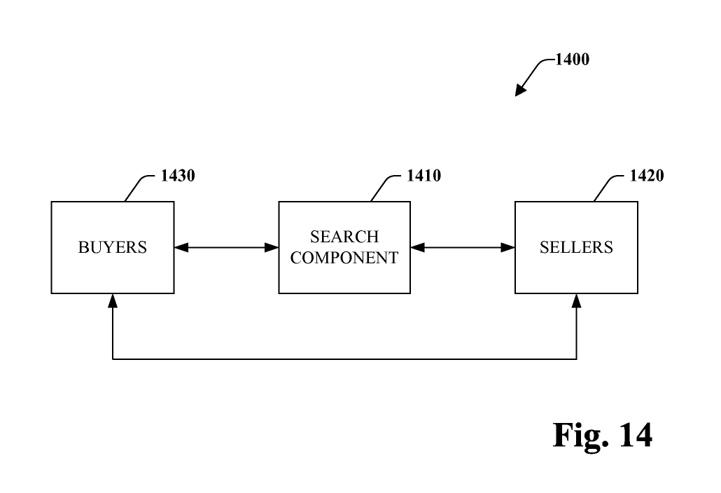

Turning now to FIG. 14, a searching system 1400 for group buying events is illustrated. Searching system 1400 includes buyers 1430 and sellers 1420. Buyers 1430 may be potential consumers seeking sellers 1420 hosting group purchasing events for particular products or class of products. For example, the buyers 1430 may be prospective consumers wishing to purchase plasma televisions. Accordingly, the buyers 1430 can utilize the searching system 1400 to discover group purchasing events for plasma televisions offered by the sellers 1420.

To facilitate discovery of group purchasing events, search component 1410 is provided. The search component 1410 indexes group purchasing events from sellers 1420 and presents the events in response to requests from buyers 1430. In one embodiment, the search component 1410 can be a web site. Accordingly, the buyers 1430 and the sellers 1420 can access the search component 1410 via a web browser on a personal computer such as Microsoft Internet Explorer®, Netscape Navigator®, Mozilla Firefox®, or the like. It is to be appreciated that the buyers 1430 and the sellers 1420 may also access the search component 1410 via a mobile device, such as a cellular phone or a personal digital assistant (PDA), or any device capable of interfacing with the search component 1410. Further, it is to be appreciated that search component 1410 may included a standalone application, applet or widget executing on a personal computer, mobile device or any processor-based device. The standalone application, applet or widget may access a central data store of group purchasing events via a network (e.g., local area network, wide area network, Internet, wireless . . . ). Accordingly, the buyers 1410 and the sellers 1430 are not restricted to interfacing with the search component 1410 via a web browser.

Buyers 1430 seeking to participate in group purchasing events for particular products or class of products provide a search query to the search component 1410. The search query can include a variety of criteria supplied by the user. The search query may include basic information that could be entered, for example, via search screen 800 from FIG. 8. It should be appreciated that the search query may also include additional criteria information. For example, the search query can comprise a description of the product, lowest current price, best potential future price, seller rating and the like. The search component 1410 utilizes the search query to discover group purchasing events hosted by sellers 1420. Group purchasing events are returned to the buyers 1430 in accordance with the search query. The returned group purchasing events may be presented to the buyers 1430 as a listing of hyperlinks. It is to be appreciated that group purchasing events may also be presented utilizing graphical means. For example, the group purchasing events may be presented as thumbnail snapshots displaying deal room 480 associated with the events. Additionally, sellers 1420 may pay for preferred placement of group purchasing events. For example, sellers 1420 may receive preferred relevancy ranking over similar group purchasing events in addition to sponsored advertising space. Accordingly, a host of system 1400 may offer levels of service to sellers 1420 to generate additional revenue beyond advertising revenue. Buyers 1430 may then choose a particular group purchasing event hosted by a particular seller. Buyers 1430 may then interact with sellers 1420 via the deal room 480 as described with regard to FIG. 4.

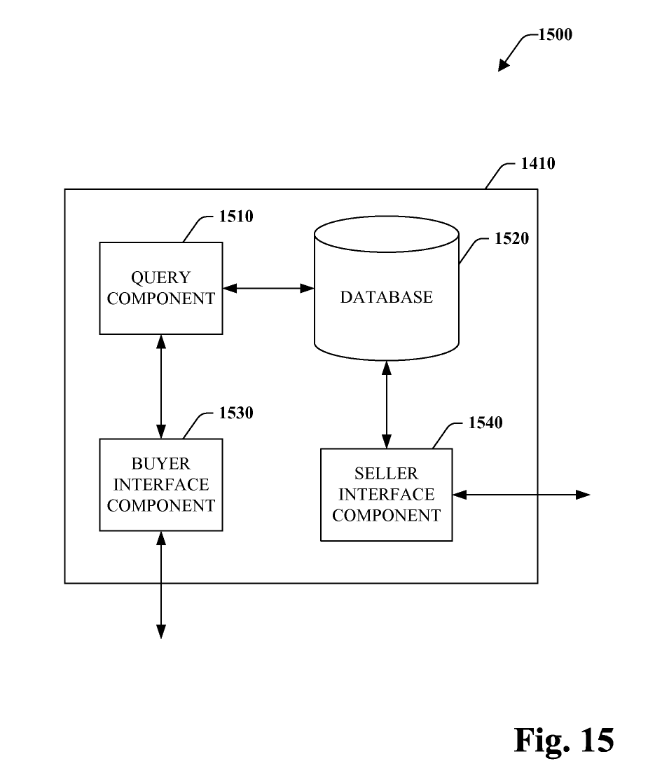

Referring now to FIG. 15, a group purchasing event searching system 1500 is depicted including a representative search component 1410. The search component 1410 includes a query component 1510 that accepts a search query from a buyer interface component 1530. Buyers 1430 input the search query via the buyer interface component 1530. The buyer interface component 1530 may be a form on a web site wherein buyers 1430 access the form via a web browser on a personal computer, mobile device or any the like. It is also to be appreciated that the buyer interface component 1530 may be a standalone application, applet or widget executing on a personal computer or mobile device. For example, buyers 1430 may input the search query via an applet on a cellular telephone. The applet communicates the search query to the query component 1510 via a network (e.g. wireless network, local area network, the Internet . . . ).

The search query can include a variety of criteria supplied by the user. For example, the criteria can comprise a description of the product, lowest current price, best potential future price, ship date, order volume minimum, warranty term, seller rating and the like. The search query is provided to query component 1510 to locate group purchasing events in accordance with the criteria included in the search query. The query component 1510 may translate the user input into a format suitable for searching a database 1520 that stores group purchasing events. The particular format utilized is dependent on the type of database and/or data model employed by the search component 1410. For example, if database 1520 is a relational database, the query component 1510 may translate the search query into Structured Query Language (SQL). If the database 1520 employs a markup data model like XML, the query component 1510 may utilize an XQuery or XPath format. Alternatively, if search query is already in a suitable format, the query component 1510 can simply pass such data through to the database 1520.

The query component 1510 is communicatively coupled to the database or database management system 1520. The query component 1510 communicates the translated search query to the database 1520, which employs the translated search query to search for group purchasing events matching the search criteria. Matching group purchasing events are retrieved and returned to the buyers 1430 via the buyer interface component 1530 for review. The matching group purchasing events may be presented to the buyers 1430 as a list of events with details of the events provided therewith. For example, each event in the list may include a name of the seller and a current price under the event. The group purchasing events may be links that enable the sellers 1420 to redirect the buyers 1430 to a deal room 480 to conduct a transaction.

Sellers 1420 may access the search component 1410 via seller interface component 1540. Similar to buyer interface component 1530, seller interface component 1540 may be a web page accessed via a web browser or an application, applet, or widget. Seller interface component 1540 is communicatively coupled to database 1520 to enable sellers 1420 to input new group purchasing events, edit existing events, delete events or the like. For example, a seller wishing to host a group purchasing event for plasma televisions may employ seller interface component 1540 (e.g. a form on a web site, an applet, a widget . . . ) to add the event to the database 1520 to be retrieved by buyers 1430.

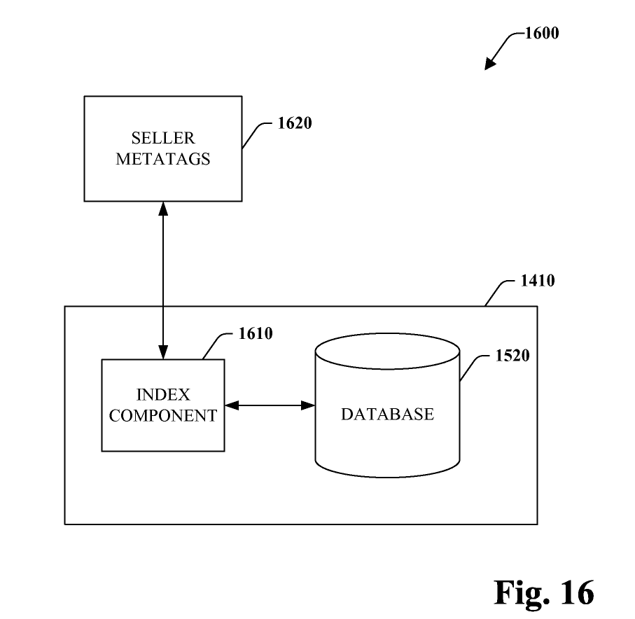

Turning to FIG. 16, a system 1600 for discovering and indexing group purchasing offers is illustrated. The system 1600 depicts representative search component 1410 including an index component 1610. The index component 1610 traverses the Internet, an intranet or other network to find group purchasing events listed by sellers 1420. In one instance, a seller can post details of a group purchasing event on the seller's website, another website (e.g. electronic magazine, online retail), a bulletin board or other such medium accessible on the Internet. Thus, group purchasing events need not be entered directly into search component 1410 by sellers 1420 in order to be retrieved by buyers 1430.

The suppliers 1420 may encode a group purchasing event in seller metatags 1620. Seller metatags 1620 can include a company name of the seller, an industry of the seller, seller locations, products and/or services offered in the event, a price curve, a warranty term, and the like. A product offered in the group purchasing events may be identified by a Universal Product Code (UPC), European Article Number (EAN) or like identifying code and/or graphic. A UPC or EAN is an alphanumeric string or a decimal string that uniquely identifies a particular products. For example, a specific 42 inch plasma television product line manufactured by a particular manufacture may be identified by a UPC, for example 035742601378, unique to that plasma television from that manufacturer. Employing UPCs enables group purchasing events including identical products but from different sellers to be efficiently linked and compared. For example, a buyer looking for a DVD player from a certain manufacturer may utilize search component 1410 to retrieve all group purchasing events from sellers offering DVD players. The UPCs enable the buyer to compare prices for a particular DVD player across a plurality of sellers. Further, UPCs enable the buyer to supply search criteria at, for example, a seller's store location. The buyer, utilizing a scanning device, can retrieve the UPCs for a desired product directly from the store shelf. For example, the buyer may utilize a camera or other imaging device on a cell phone or PDA to capture the UPC. The scanned UPC may be transmitted to the search component 1410 to discover group purchasing events including products matching the scanned UPC.

The index component 1610 can locate seller metatags 1620 corresponding to group purchasing events. The index component 1610 retrieves the metatags 1620 from a website of other location storing the metatags 1620 and parses the metatags 1620 to identify the component parts of the group purchasing event. After parsing the metatags 1620 and distilling the essence of the event, index component 1610 indexes the event and stores it in database 1520 for future retrieval by buyers 1430 employing search component 1410. Database 1520 can be a relational database management system but it should be appreciated that other data store formats may be employed.

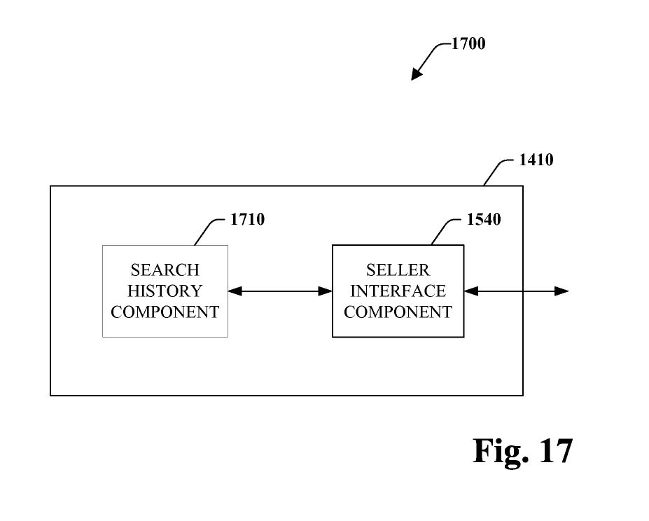

FIG. 17 depicts a searching system 1700 including a representative search component 1410 in accordance with an aspect of the subject disclosure. The search component 1410 includes a search history component 1710 communicatively coupled to seller interface component 1540. The search history component 1710 compiles a complete search history of buyers 1430 utilizing search component 1410. For example, as a buyer inputs a search query into search component 1410, search history component 1710 records the search query. It should be appreciated that search component 1410 may employ a registration system enabling access to the search system only to registered buyers. In such a case, search history component 1710 may also include a username of other such identifier of the buyers. The search history component 1710 may also record a timestamp value. For example, if Buyer A searches for 60 inch DLP televisions at 8:30 on December 13, the search history component 1710 may record “12/13 08:30 Buyer A 60-inch DLP televisions.”

The search history data recorded by the search history component 1710 is accessible by sellers 1420 via seller interface component 1540. Seller interface component 1540 enables sellers 1420 to retrieve the search history data according to particular criteria or level of granularity. For example, a seller could retrieve data at a low level of granularity such as a list of buyers who searched for DVD players. Also, a search could retrieve data at a higher level of granularity such as a numeric count of buyers searching for plasma televisions. Additionally, subsets of the search history data can be retrieved in accordance with particular time periods. For example, a seller can retrieve buyers searching for a particular product in the past 30 days.

Search history component 1710 may have data mining capabilities. For example, search history component 1710 may employ artificial intelligence techniques in data mining search history data to discern patterns among the buyers 1430. Sellers 1420 may employ the discovered search patterns in the development of new group purchasing events. For example, sellers 1420 may construct group purchasing events targeting particular buyers or offering certain products that would be of particular interest to buyers 1430 based up on the search patterns.

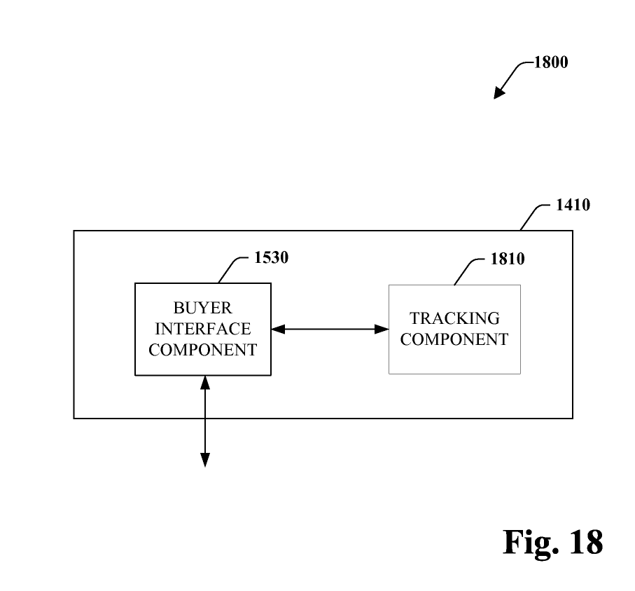

Turning now to FIG. 18, a group purchasing event tracking system 1800 is illustrated. Search component 1410 includes a tracking component 1810 that is communicatively coupled to buyer interface component 1530. The tracking component 1810 enables buyers 1430 via the buyer interface component 1530 to track or monitor group purchasing events. Group purchasing events can include price curves whereby a price for a product and/or service varies according to a total amount purchased/ordered by a buying group. For examples, as more buyers buy more products and/or services under a particular group purchasing event, the price for the products and/or services may decrease for all buyers.

Buyers 1430 may elect group purchasing events to be tracked or monitored by the tracking component 1810. The tracking component 1810 observes the group purchasing events and updates the buyers 1430 of any changes in price, quantity ordered or the like. For example, a buyer may elect to track a group purchasing event wherein plasma televisions are offered. The tracking component 1810 informs the buyer whenever the price of the plasma televisions changes due to additional orders under the event (e.g. decrease in price) or to returns of products purchases under the event (e.g. increase in price).

Buyers 1430 may also track group purchasing events by item, price and/or seller instead of just monitoring particular events. For example, a buyer may select to monitor group purchasing events for plasma televisions. Tracking component 1810 will update the buyer of the top n events for plasma televisions, where n is threshold value supplied by the buyer via the buyer interface component 1530. For example, the buyer may desire to observe the top three plasma television group purchasing events sorted according to lowest price. As orders and/or returns occur in events for plasma televisions, tracking component 1810 updates the top three list when certain events overtake other events. Additionally, a target price can be set and tracking component 1810 alerts buyers whenever an event reaches the target price. For example, a buyer may set a target price of $1,000 for 50 inch plasma televisions. Tracking component 1810 alerts the buyer whenever a group purchasing event satisfies that target price. Buyer interface component 1530 may be a mobile device such as a cell phone or a PDA. Accordingly, the buyer may be alerted to the group purchasing event directly on the buyer's mobile device. It is also to be appreciated that the group purchasing event in the target can be indicated on a web site of search component 1410 whenever the buyer accessing the web site. Further, buyer interface component 1530 may be an applet or widget. Thus, the buyer may also employ a standalone applet or widget on a personal computer that accepts updates from tracking component 1810.

In addition to buyers 1430 tracking group purchasing events, the location of buyers 1430 may be monitored to provide context in accordance with an aspect of the subject disclosure. The position of buyers 1430 may be determined via a mobile device. For example, a buyer may be located via a GPS enables cell phone, PDA or the like. The buyer, passing by a particular store, may be presented with a deal notification on the mobile device regarding a product of interest to the buyer offered by the store. The interest level may be determined from the group purchasing events tracked by the buyer and/or from the buyer's search history. If the product matches tracked group purchasing events, the buyer, via the mobile device, may compare the deal notification with the group purchasing events to determine if the new deal is fair.

The aforementioned systems, architectures and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. Communication between systems, components and/or sub-components can be accomplished in accordance with either a push and/or pull model. The components may also interact with one or more other components not specifically described herein for the sake of brevity, but known by those of skill in the art.

Furthermore, various portions of the disclosed systems and methods may include or consist of artificial intelligence, machine learning, or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the search engine component 1410 can utilize such techniques to facilitate provisioning of relevant search results to users as a function of context including user, third party and environmental context. For example, the search engine component 1410 can infer that a user may be interested in a particular deal as a function of previous purchases, the time of year, business and/or personal needs, among other things. Furthermore, such deals may be pushed to a user without explicit/manual initiation of a search, for instance as a notification generated as a result of standing or automatic search query as a function of context.

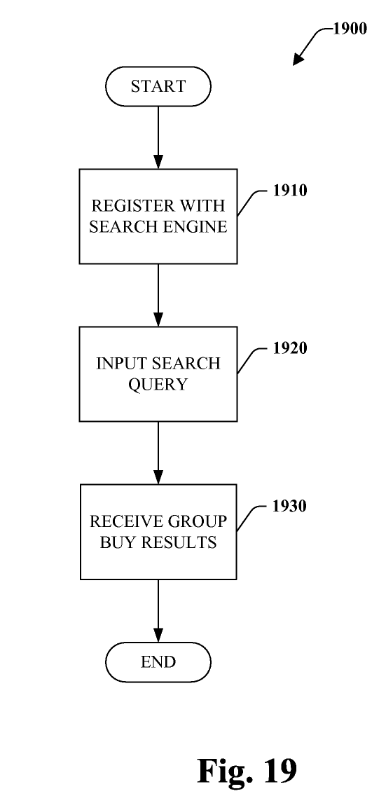

In view of the exemplary systems described supra, methodologies that may be implemented in accordance with the disclosed subject matter will be better appreciated with reference to the flow charts of FIGS. 19 through 22. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Referring now to FIG. 19, a method for group buy searching 1900 is provided. In particular, a search engine can be employed to gather group purchasing events. A buyer utilizing the search engine can then retrieve those events.

At reference numeral 1910, a registration for the search engine functionality is supplied. A buyer seeking to utilize the search engine to discover group purchasing events can register with the search engine or associated service. The buyer can fill out a registration form to gain access to the search engine. The registration form can include, among other things, a username and pass code (e.g., password, random series of alphanumeric characters . . . ) associated with the buyer. The buyer utilizes the username and pass code to access the search engine and to enable to the search engine to track the buyer's searching sessions.

At reference numeral 1920, a search query is input. Search criteria can be supplied by a buyer seeking to purchase products and/or services described by the search criteria. The search criteria can include, among other things, a description of the product, lowest current price, best potential future price, ship date, order volume minimum, warranty term, and/or seller rating.

At numeral 1930, relevant group buy events are discovered. Relevancy of an offer can be determined by comparing the details of the event with the search query inputted at numeral 1920. A search engine may be employed to retrieve offers from a data store utilizing a database query based upon the search query. The retrieved offers can be presented to the buyer supplying the input query numeral 1920.

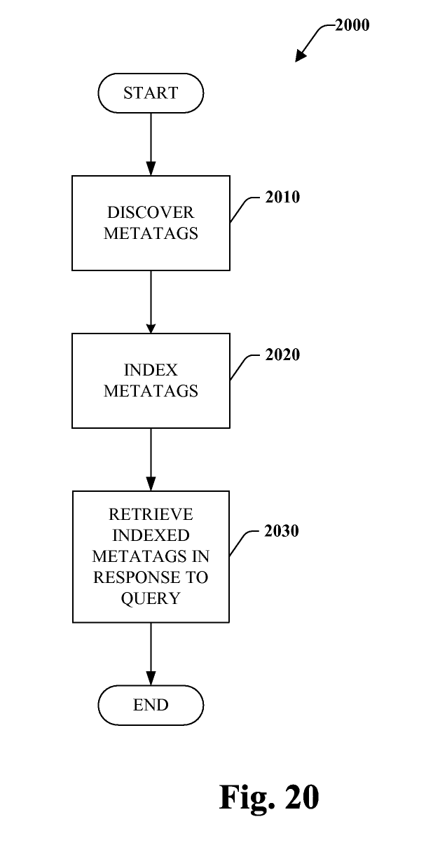

Turning now for FIG. 20, a method of identifying group purchasing events 2000 is provided. At reference numeral 2010, metatags or the like corresponding to a group purchasing event can be discovered by a spider, crawler or index component, for example, by traversing the Internet or other network. The metatags may include a company name of the seller, an industry of the seller, seller locations, products and/or services offered in the event, a UPC, a price curve, a warranty term, time period of the event and the like. At numeral 2020, metatags are parsed and the details of the group purchasing event are indexed in a data store. At reference numeral 2030, a search query is received relevant to the discovered metatags of the group purchasing event. The metatags are retrieved from the data store and the group purchasing event may be presented to a potential consumer.

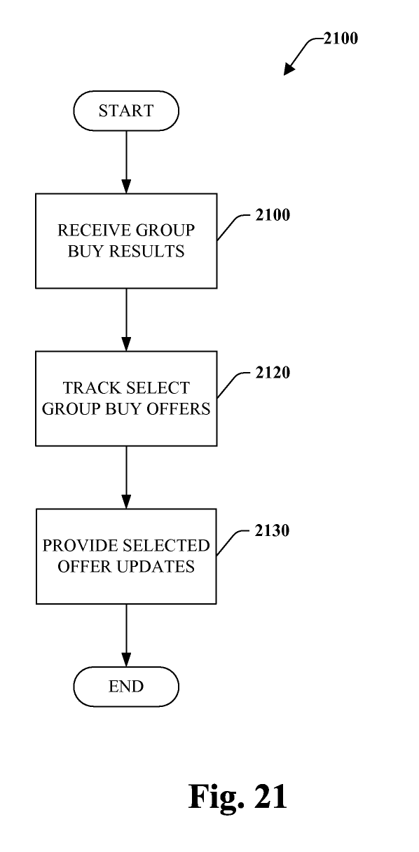

FIG. 21 depicts a method 2100 for tracking group purchasing events. At reference numeral 2110, group purchasing events are received. A search engine may be employed to retrieve the group purchasing events in accordance with a search query input. At reference numeral 2120, a subset of the received events is elected to be tracked or monitored. The subset may comprise all received events, a single event, or any number of the received events. At numeral 2130, updates are provided relating to changes in the events due to purchases and/or returns under the group purchasing events. For example, a widget or other element of a graphical user interface can provision information to a user regarding the current price of an item of interest or one that has already be purchased.

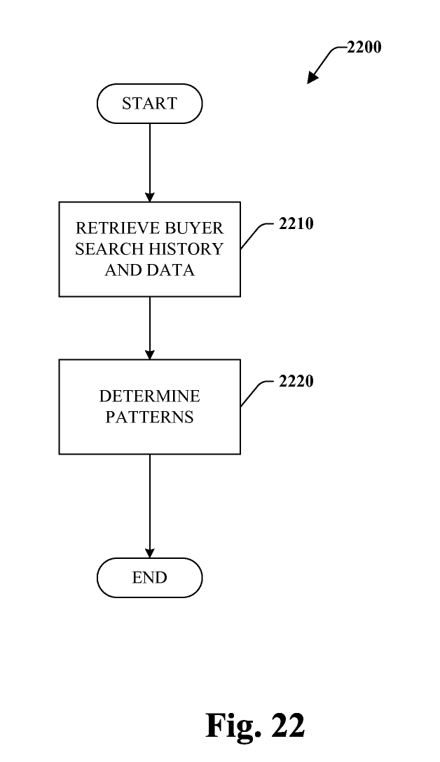

Referring now to FIG. 22, a method of determining buyer search patterns 2200 is provided. At reference numeral 2210, buyer search history data is received. Buyer search history data may include a buyer identifier, product identifiers, time stamps and the like. Buyer search history data may include search histories of all buyers utilizing a search engine or a subset of all buyers. At numeral 2220, patterns are discerned from the buyer search history data. Artificial intelligence techniques may be employed to data mine the data to determine, among other things, potential buyer purchasing habits, buyer interest, seller popularity, and product popularity.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” is used herein to mean serving as an example, instance or illustration. Any aspect or design described herein as “exemplary” is not necessarily to be construed as preferred or advantageous over other aspects or designs. Furthermore, examples are provided solely for purposes of clarity and understanding and are not meant to limit the subject innovation or relevant portion thereof in any manner. It is to be appreciated that a myriad of additional or alternate examples could have been presented, but have been omitted for purposes of brevity.

Furthermore, all or portions of the subject innovation may be implemented as a method, apparatus or article of manufacture using standard programming and/or engineering techniques to produce software, firmware, hardware, or any combination thereof to control a computer to implement the disclosed innovation. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

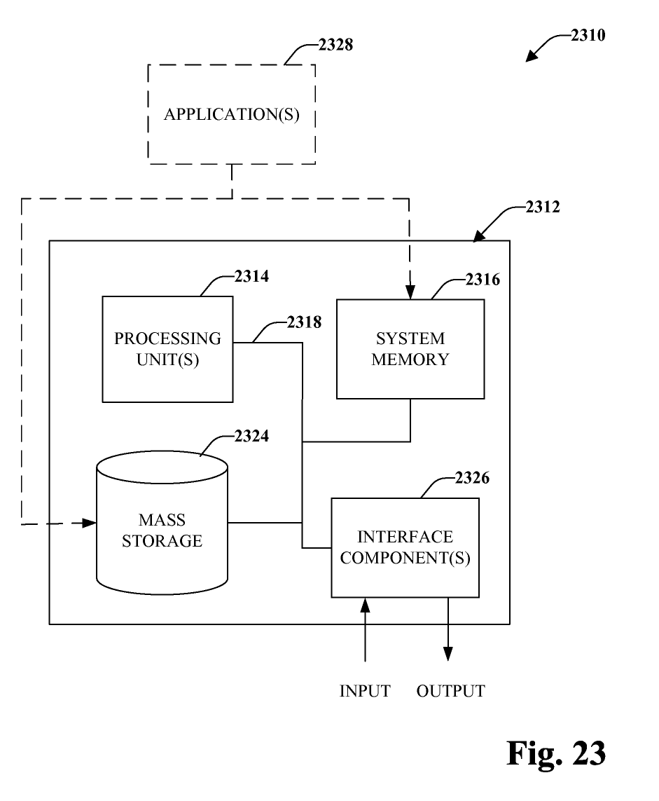

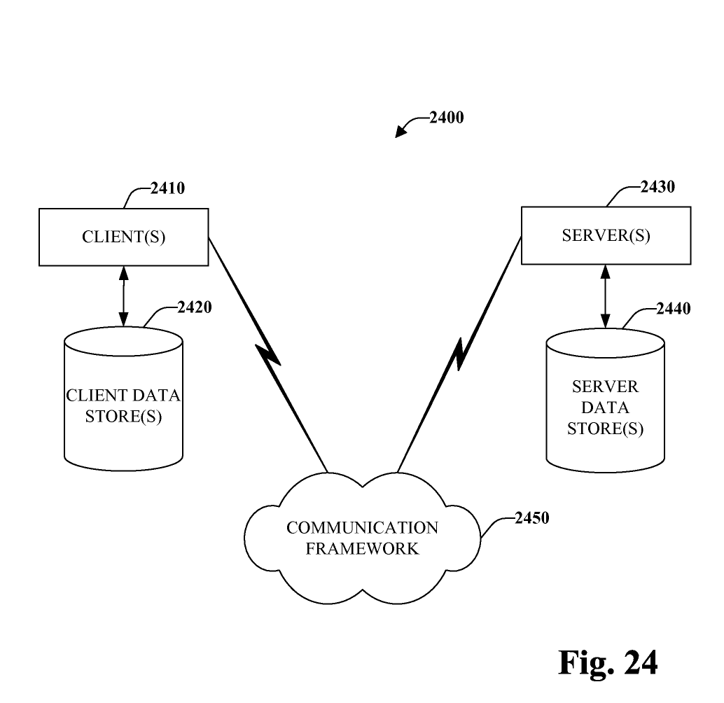

In order to provide a context for the various aspects of the disclosed subject matter, FIGS. 23 and 24 as well as the following discussion are intended to provide a brief, general description of a suitable environment in which the various aspects of the disclosed subject matter may be implemented. While the subject matter has been described above in the general context of computer-executable instructions of a program that runs on one or more computers, those skilled in the art will recognize that the subject innovation also may be implemented in combination with other program modules. Generally, program modules include routines, programs, components, data structures, etc. that perform particular tasks and/or implement particular abstract data types. Moreover, those skilled in the art will appreciate that the systems/methods may be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the claimed subject matter can be practiced on stand-alone computers. In a distributed computing environment, program modules may be located in both local and remote memory storage devices.

With reference to FIG. 23, an exemplary environment 2310 for implementing various aspects disclosed herein includes a computer 2312 (e.g., desktop, laptop, server, hand held, programmable consumer or industrial electronics . . . ). The computer 2312 includes a processing unit 2314, a system memory 2316 and a system bus 2318. The system bus 2318 couples system components including, but not limited to, the system memory 2316 to the processing unit 2314. The processing unit 2314 can be any of various available microprocessors. It is to be appreciated that dual microprocessors, multi-core and other multiprocessor architectures can be employed as the processing unit 2314.

The system memory 2316 includes volatile and nonvolatile memory. The basic input/output system (BIOS), containing the basic routines to transfer information between elements within the computer 2312, such as during start-up, is stored in nonvolatile memory. By way of illustration, and not limitation, nonvolatile memory can include read only memory (ROM). Volatile memory includes random access memory (RAM), which can act as external cache memory to facilitate processing.

Computer 2312 also includes removable/non-removable, volatile/non-volatile computer storage media. FIG. 23 illustrates, for example, mass storage 2324. Mass storage 2324 includes, but is not limited to, devices like a magnetic or optical disk drive, floppy disk drive, flash memory or memory stick. In addition, mass storage 2324 can include storage media separately or in combination with other storage media.

FIG. 23 provides software application(s) 2328 that act as an intermediary between users and/or other computers and the basic computer resources described in suitable operating environment 2310. Such software application(s) 2328 include one or both of system and application software. System software can include an operating system, which can be stored on mass storage 2324, that acts to control and allocate resources of the computer system 2312. Application software takes advantage of the management of resources by system software through program modules and data stored on either or both of system memory 2316 and mass storage 2324.

The computer 2312 also includes one or more interface components 2326 that are communicatively coupled to the bus 2318 and facilitate interaction with the computer 2312. By way of example, the interface component 2326 can be a port (e.g., serial, parallel, PCMCIA, USB, FireWire . . . ) or an interface card (e.g., sound, video, network . . . ) or the like. The interface component 2326 can receive input and provide output (wired or wirelessly). For instance, input can be received from devices including but not limited to, a pointing device such as a mouse, trackball, stylus, touch pad, keyboard, microphone, joystick, game pad, satellite dish, scanner, camera, other computer and the like. Output can also be supplied by the computer 2312 to output device(s) via interface component 2326. Output devices can include displays (e.g. CRT, LCD, plasma . . . ), speakers, printers and other computers, among other things.

FIG. 24 is a schematic block diagram of a sample-computing environment 2400 with which the subject innovation can interact. The system 2400 includes one or more client(s) 2410. The client(s) 2410 can be hardware and/or software (e.g., threads, processes, computing devices). The system 2400 also includes one or more server(s) 2430. Thus, system 2400 can correspond to a two-tier client server model or a multi-tier model (e.g., client, middle tier server, data server), amongst other models. The server(s) 2430 can also be hardware and/or software (e.g., threads, processes, computing devices). The servers 2430 can house threads to perform transformations by employing the aspects of the subject innovation, for example. One possible communication between a client 2410 and a server 2430 may be in the form of a data packet transmitted between two or more computer processes.

The system 2400 includes a communication framework 2450 that can be employed to facilitate communications between the client(s) 2410 and the server(s) 2430. Here, the client(s) can correspond to search engine user (e.g. buyers or sellers) computing devices and the server(s) can provide the functionality of the group purchasing event search systems, as previously described. The client(s) 2410 are operatively connected to one or more client data store(s) 2460 that can be employed to store information local to the client(s) 2410. Similarly, the server(s) 2430 are operatively connected to one or more server data store(s) 2440 that can be employed to store information local to the servers 2430. By way of example, a user (e.g., buyer and/or seller) can login to one or more servers 2430 via a client 2410 and provide a profile including information about the user corresponding to the user's identity. The server(s) 2430 can persist this information to data store(s) 2440.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” or variations in form thereof are used in either the detailed description or the claims, such terms are intended to be inclusive in a manner similar to the term “comprising” as “comprising” is interpreted when employed as a transitional word in a claim.

1. A system for searching for group buying events, the system comprising:
at least one processor coupled to memory; and
memory having embodied thereon instructions executable by the at least one processor to:
index group purchasing events sponsored by associated sellers;
store the group purchasing events to a database, wherein a group purchasing event indexed and stored to the database represents an offer for an item at a discounted price based on a minimum volume of orders received from a plurality of buyers within a pre-defined period of time;
receive a search query from a first user;
identify group purchasing events included in the database based upon the search query;
present to the first user multiple identified group purchasing events; and
present at least one offer for display on a mobile device, the offer selected, in part, based on location information associated with the user.

2. The system of claim 1, wherein the memory is further embodied with instructions executable by the at least one processor to accept a search query for group purchasing events from a second user, the group purchasing events indexed in the database.

3. The system of claim 2, wherein the memory is further embodied with instructions executable by the at least one processor to provide a subset of full search history data to the second user.

4. The system of claim 1, wherein the memory is further embodied with instructions executable by the at least one processor to:
initiate a crawling process that discovers seller metatags on a remote system;
index associated group purchasing events; and
store associated group purchasing events.

5. The system of claim 4, wherein the seller metatags identify a group purchasing event.

6. The system of claim 5, wherein the group purchasing event includes one or ore of the following: the discounted price, a time period, a universal product code, a ship date, a quantity, or an order volume.

7. (canceled)

8. The system of claim 1, wherein the memory is further embodied with instructions executable by the at least one processor to aggregate orders placed during an established time period to determine a final price.

9. The system of claim 1, wherein the memory is further embodied with instructions executable by the at least one processor to provide updated group purchasing event data based upon criteria supplied by the sellers.

10-11. (canceled)

12. The system of claim 1, wherein the memory is further embodied with instructions executable by the at least one processor to present group purchasing events to the first user based upon a relevancy to the search query.

13. A method of searching for group buying events, the method comprising:
executing instructions stored in memory to index group buying events advertised by sellers, the instructions executed by way of one or more processors;
store the group buy events in a database, wherein a group buy event indexed and stored to the database represents an offer for an item at a discounted price based on a minimum volume of orders received from a plurality of buyers within a pre-defined period of time;
receive a search query from a user by way of a communications interface;
execute instructions stored in memory to retrieve from the database stored group buying events based at least upon the received search query; and
presenting the retrieved group buy events to the user for display on a mobile device, the offers selected in part based on location information associated with the user, and wherein the retrieved group buying events include offers from different sellers.

14. The method of claim 13, wherein one or more of the group buying events include a universal product code, a product category, or an image.

15-16. (canceled)

17. The method of claim 13, further comprising executing instructions stored in memory to track interest in selected group buying events.

18. The method of claim 17, further comprising executing instructions stored in memory to track group buying events, including;
monitoring group buy purchases in a group buy event, and
updating a status associated with group buy events based upon aggregated purchases.

19. (canceled)

20. A non-transitory computer readable storage medium having embodied thereon instructions executable by a processor to perform a method of searching group buying events, the method including:
indexing group buying events sponsored by at least one seller that represent offers for items at discounted prices;
storing the group buying events in a database, including a minimum volume of orders received from a plurality buyers within a pre-defined period of time;
retrieving group buy events based upon criteria supplied by consumers, wherein retrieved group buy events includes group buy events from multiple different sellers;
monitoring changes in retrieved group buy events; and
transmitting the retrieved group buy events and corresponding changes to a user for display on a mobile device based in part on location information associated with the user.

21-22. (canceled)

23. The system of claim 8, wherein the memory is further embodied with instructions executable to aggregate a particular order contingent upon a buyer that places the order first accepting terms and conditions governing sale of the item provided by a seller associated with the offer.

24-25. (canceled)

26. The system of claim 30, wherein the subset of the full search history data includes a timestamp associated with a previous search query.

27. (canceled)

28. The system of claim 1, wherein the offer is a current offer.

29. The system of claim 1, wherein the offer is a future offer.

30. The system of claim 2, wherein the memory is further embodied with instructions executable by the at least one processor to provide full search history data to the second user.

31. The system of claim 1, wherein the memory is further embodied with instructions executable by the at least one processor to aggregate orders placed during an established time period to determine a final price order volume from a plurality of buyers to meet a volume threshold.

32. The system of claim 1, wherein the memory is further embodied with instructions executable by the at least one processor to present group purchasing events to the first user based upon a status of the group purchasing event.

33. The system of claim 1, wherein the memory is further embodied with instructions executable by the at least one processor to present group purchasing events to the first user based upon a location.

34. The method of claim 13, wherein the offer is a current offer.

35. The method of claim 13, wherein the offer is a future offer.
